(19) United States
(12) Patent Application Publication
(10) Pub. No.: US 2003/0151908 A1
(43) Pub. Date: Aug. 14, 2003

(54) Glow in the dark keyboard members for illuminating a keyboard

(76) Inventor: Brian Fried, Smithtown, NY (US)

Correspondence Address: Philip M. Weiss, Weiss & Weiss, 500 Old Country Road, Garden City, NY, 11530, US

(21) Appl. No.: 10/071,669

(22) Filed: Feb. 8, 2002

(51) Int. Cl. F21V 9/16; F21V 33/00

(52) U.S. Cl. 362/84; 362/85

(57) ABSTRACT

The present invention provides keyboard members that can glow in the dark for illuminating a keyboard.

### FIELD OF THE INVENTION

The present invention relates to providing keyboard members that can glow in the dark for illuminating a keyboard.

### BACKGROUND OF THE INVENTION

In the prior art keyboards it is difficult to discern the symbol appearing on the top of the key member under poor lighting conditions.

Many people use their computers in the evening in places where illumination may not be proper for typing. Many persons take their computers away from their offices and homes, on trains, planes and other means of travel. Some persons type in their bedrooms at night but do not want to disturb other persons by putting a light on. Therefore it is important to come up with a way of illuminating the keyboard of a computer or typewriter to assist a person in seeing the keys.

The versatility of the portable laptop computer is limited by the amount of ambient light available. There are devices today that are illuminators or lights which are added to the computer. However, these devices are bulky and may annoy other people who are in the room.

U.S. Pat. No. 6,145,992 relates to a keyboard illuminator and a method for illuminating a keyboard for use by a computer user operating a computer having a keyboard, a housing and a display that emits light. The keyboard illuminator includes a rigid planar member that is at least partially transmitting and at least partially reflecting and an apparatus for mounting the member on the housing. The member is mounted so that the member is disposed at an angle to the display screen between the display screen and the user such that at least a portion of light emitted by the display screen is reflected onto the keyboard to illuminate the keyboard for operation.

U.S. Pat. No. 5,660,694 relates to a self-activated keyboard illuminator and accessory. A keyboard lighting fixture includes a base for securing to the underside of keyboards or directly onto the workstation, stabilizing the light fixture to allow pivoting of the housing. The pivoting of the housing to a desired operational position energizes the system which is powered by a plug-in transformer. A second embodiment shows a copy text illuminator, half the size of the keyboard light and powered by a cord that connects the two light fixtures, making it an auxiliary fixture, to the keyboard light. The auxiliary light fixture is powered via the keyboard light or via a stand-alone transformer.

U.S. Pat. No. 6,217,183 relates to a keyboard having illuminated keys. The keyboard includes a light channeling membrane and key members constructed at least partially of translucent material so that light produced from a light source is channeled upwardly to the upper surfaces of the key members.

Keyboard and keypad backlighting devices which utilize LED, LCD or fiber optics are relatively expensive to construct. In addition, light sources for use with prior art backlit keyboards require substantial power and in some cases, a fan for cooling which draws additional power. These constructions are prohibitive for portable computers such as laptop and notebook computers which draw on the power of a rechargeable battery and where power is at a premium.

### SUMMARY OF THE INVENTION

The present invention relates to a device for providing illumination to a keyboard when the environment does not provide enough light. It is an object of the present invention for the device to comprise glow in the dark stickers which are attached to the keyboard. It is an object of the present invention for the stickers to be permanently or removably attached to the keyboard. It is an object of the present invention to illuminate the key members using an inexpensive and simple stickon.

It is an object of the present invention to illuminate the keyboard without the use of power from the computer, nor does the invention require a separate power source. It is an object of the present invention to make the keyboard key members more discernable in low light conditions. It is an object of the present invention to have a keyboard which is illuminated for use with today's computer systems including portable computers.

It is an object of the present invention to have the characters of the keyboard placed on the glow in the dark stickers so that the stickon can be placed right over the specific key member.

It is an object of the present invention for the glow in the dark sticker to have an opening which allows the characters on the key members to be seen.

It is an object of the present invention to make the keyboard members of a material that glows in the dark.

### DETAILED DESCRIPTION OF THE INVENTION

In an embodiment of the present invention, the keyboard members are constructed of a substantially non-deformable material, the key members depressably positioned within the keyboard housing. The key members include at least twenty-six key members having letters displayed thereon.

Conventional keyboards include a plurality of key members which display symbols, such as alphanumeric keys, on their top surfaces. Moreover, typical modem keyboards for both electric typewriters and computers utilize a make and break electrical circuit which is activated by depression of a key member for identifying a particular symbol embedded on the top of the key member.

A typical computer has a keyboard, central processing unit and monitor. By pressing key members on the keyboard, one sends signals to the central processing unit instructing the computer to perform various functions. A typical keyboard includes a housing. The keyboard further includes a plurality of key members and a diaphragm having elastic diaphragm projections for biasing the key members to a normally upward position. A typical computer keyboard further includes a circuit board which is disposed below the key members and diaphragm. The circuit board includes first and second printed wiring layers which include engraved or embedded electrical circuits. The printed wiring layers are separated by an insulator or dielectric layer. The insulator layer includes a plurality of holes so that depression downwardly of the key members causes the diaphragm projection to be forced downwardly upon the printed wiring layer so that printed wiring layers can come in contact to open and close distinctive electrical switches through the holes of the insulator layer. Each of these electrical switches correspond to different key members so that the keyboard operator can depress key members either individually or in combination to send various signals to the computer's central processing unit.

The present invention provides illumination to a keyboard when the environment does not provide enough light. In one embodiment of the present invention, glow in the dark stickers are attached to the keys of the keyboard. The stickers can be permanently or removably attached to the keyboard. The stickers can be inexpensive and simple stickons that illuminate the keyboard. In a further embodiment, the stickers can be for children and therefor in the form of animals. However, the main purpose of the stickers is to allow a user to see the keys of a computer or typewriter terminal when the lighting is insufficient.

The present invention does not require the use of power from the computer, nor does the invention require a separate power source to illuminate the keyboard.

In an embodiment of the present invention the keyboard members are made of a material that glows in the dark. The keyboard members can be made of any material, for example plastic which is coated with a substance that glows in the dark allowing a user to see the letters, numerals, etc. on the keyboard when there is poor or no illumination provided external to the computer.

In a further embodiment, the flow in the dark stickers have the characters of each keyboard member on the sticker. The glow in the dark sticker is placed directly over the corresponding key member having that character.

In an embodiment of the present invention, the glow in the dark stickers have an opening which allows the characters on the key members to be seen through the opening. In this embodiment, it is not necessary to print the characters on the stickers.

1. A device for providing illumination to a keyboard comprising;
glow in the dark stickers which are attached to keys of said keyboard.

2. The device of claim 1 wherein said stickers are permanently attached to said keys.

3. The device of claim 1 wherein said stickers are removably attached to said keys.

4. The device of claim 1 wherein said stickers are in the shape of animals.

5. The device of claim 1 wherein characters on said keys are printed on said stickers.

6. The device of claim 1 further comprising:
an opening in said sticker which allows a character on said key to be seen.

7. A device for providing illumination to a keyboard comprising;
keyboard members;
said keyboard members made of a material that glows in the dark.

8. The device of claim 7 wherein said keyboard members are made of a plastic material which is coated with a substance that glows in the dark allowing a user to see letters, numerals, etc. on said keyboard when there is poor or no illumination provided external to said keyboard.

9. A device for providing illumination to a keyboard comprising;
keyboard members constructed of a substantially non-deformable material,
said key members depressably positioned within a keyboard housing;
said key members including at least twenty six key members having letters displayed thereon on their top surface;
said key members made of a material that glows in the dark.

10. The device of claim 9 further comprising:
a make and break electrical circuit which is activated by depression of a key member for identifying a particular symbol embedded on top of said key member.

11. The device of claim 9 wherein said keyboard members are made of a plastic material which is coated with a substance that glows in the dark allowing a user to see letters, numerals, etc. on said keyboard when there is poor or no illumination provided external to said keyboard.
